(19) United States
(12) Patent Application Publication
(10) Pub. No.: US 2025/0386094 A1
(43) Pub. Date: Dec. 18, 2025

(54) ELECTRONIC APPARATUS, ITS CONTROL METHOD, AND A STORAGE MEDIUM

(71) Applicant: CANON KABUSHIKI KAISHA, Tokyo (JP)

(72) Inventor: TAKU ITO, Kanagawa (JP)

(21) Appl. No.: 19/208,987

(22) Filed: May 15, 2025

(30) Foreign Application Priority Data
Jun. 17, 2024 (JP) 2024-097626

(51) Int. Cl. H04N 23/65; H04N 23/53; H04N 23/62; H04N 23/63; H04N 23/667; H04N 23/90

(52) U.S. Cl. CPC H04N 23/651; H04N 23/531; H04N 23/62; H04N 23/631; H04N 23/667; H04N 23/90

(57) ABSTRACT

An electronic apparatus includes a first imaging unit including a first image sensor, and at least one processor that executes instructions to determine whether a user is detected in an image acquired by the first imaging unit, and set a power state to a first power state or a second power state consuming more power than that of the first power state according to a determination result and an operation status of a user.

### BACKGROUND

### Technical Field

The disclosure relates to an electronic apparatus, its control method, and a storage medium.

### Description of Related Art

Some conventional electronic apparatuses have an image sensor configured to image a user. Such electronic apparatuses can determine whether or not a user is using the electronic apparatus by analyzing an image captured by the image sensor, and provide specific control. U.S. Pat. No. 8,723,979 discloses a method for starting display on a display unit in a case where a user is imaged by an image sensor. Japanese Patent Application Laid-Open No. 2023-084506 discloses a method for transitioning to an operating state with high power consumption or an operating state with low power consumption according to whether or not a user is imaged by an image sensor.

In the methods disclosed in U.S. Pat. No. 8,723,979 and Japanese Patent Application Laid-Open No. 2023-084506, the user may not be imaged by the image sensor depending on an operation status, and the user detection may be erroneously determined.

### SUMMARY

An electronic apparatus according to one aspect of the disclosure includes a first imaging unit including a first image sensor, and at least one processor that executes instructions to determine whether a user is detected in an image acquired by the first imaging unit, and set a power state to a first power state or a second power state consuming more power than that of the first power state according to a determination result and an operation status of a user. An electronic apparatus according to another aspect of the disclosure includes a first imaging unit, and at least one processor that executes instructions to determine whether a user is detected in an image acquired by a first imaging unit, set a power state to a first power state or a second power state consuming more power than that of the first power state according to a determination result, and set the power state to the second power state in a predetermined status regardless of a determination result. A control method for each of the above electronic apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIGS. 1A and 1B are external views of an image pickup apparatus according to each embodiment.

FIG. 2 is a block diagram of an imaging system according to each embodiment.

FIG. 3 is a flowchart illustrating processing of an image pickup apparatus according to a first embodiment.

FIG. 4 is a flowchart illustrating processing of an image pickup apparatus according to a second embodiment.

FIG. 5 is a flowchart illustrating processing of an image pickup apparatus according to a third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

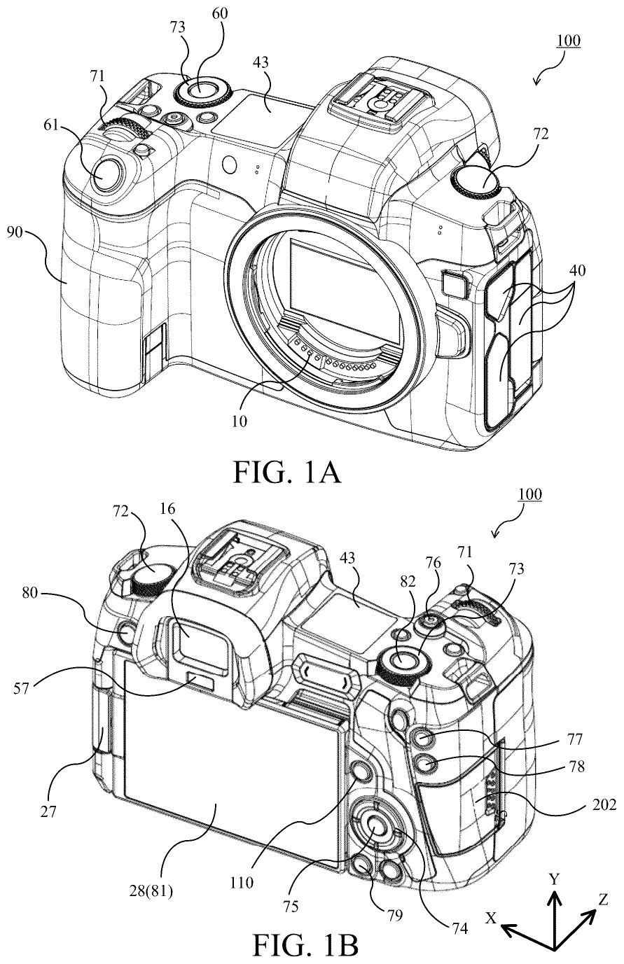

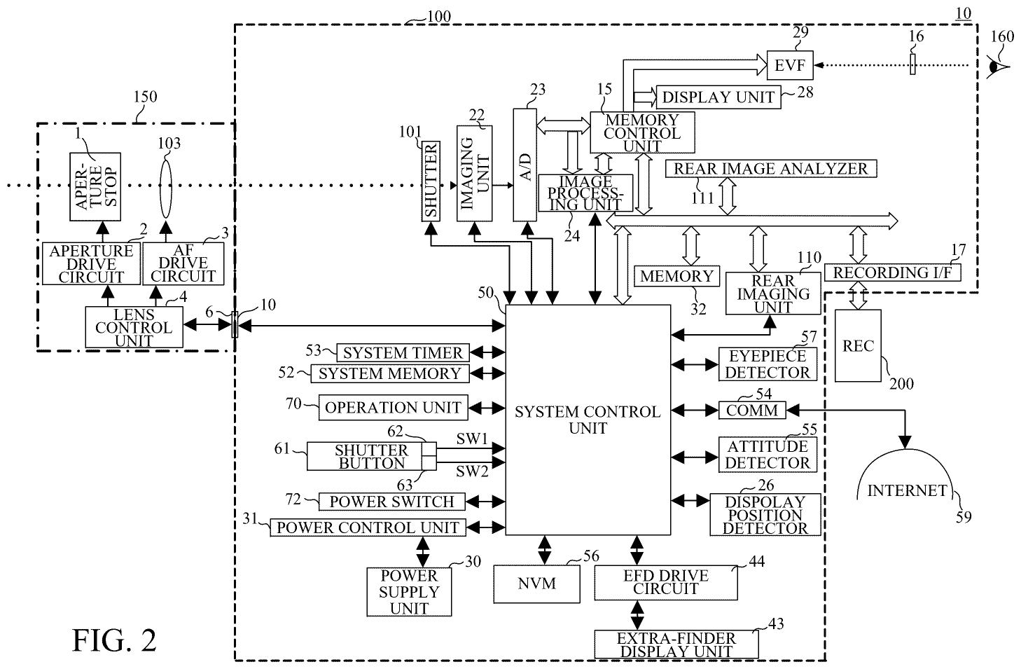

Referring now to FIGS. 1A, 1B, and 2, a description will be given of an electronic apparatus according to each embodiment. Each embodiment will discuss an image pickup apparatus (digital camera, camera body) 100 as an example of an electronic apparatus, but is also applicable to electronic apparatuses other than the image pickup apparatus.

FIGS. 1A and 1B are external views of the image pickup apparatus 100. FIG. 1A illustrates a front perspective view of the image pickup apparatus 100, and FIG. 1B illustrates a rear perspective view of the image pickup apparatus 100. In FIG. 1B, a display unit 28 is provided on the rear surface of the image pickup apparatus 100 and displays images and various information, for example, an image captured by an imaging unit 22. A touch panel 81 is included in an operation unit 70, and configured to detect a touch operation on a display surface (operation surface) of the display unit 28. A display movable unit 27 is a movable unit configured to change the position and attitude of the display unit 28. The display movable unit 27 enables the display unit 28 to rotate around a Y-axis and around an X-axis in the XYZ coordinate system fixed to the display movable unit 27 illustrated in FIG. 1B.

In each embodiment, a position where the display unit 28 is accommodated in the back of the image pickup apparatus 100 as illustrated in FIG. 1B is set to a reference position. In each embodiment, changing the position and attitude of the display unit 28 from the reference position by the display movable unit 27 will be referred to as “movement of the display unit 28 from the reference position.” In FIG. 1B, the display movable unit 27 is a vari-angle type movable unit, but each embodiment is not limited to this example, and may use a movable unit using another movable method such as a tilt type movable part.

An extra-finder display unit 43 is a display unit provided on the top surface of the image pickup apparatus 100, and displays a variety of setting values of the image pickup apparatus 100 such as a shutter speed or an aperture value (F-number). A shutter button 61 is an operation unit configured to issue an imaging instruction. A mode switch 82 is included in the operation unit 70 and is an operation unit for switching between a variety of modes. A terminal cover 40 is a cover that protects a connector (not illustrated) that connects a connection cable with an external device to the image pickup apparatus 100.

A main electronic dial 71 is a rotational operation unit included in the operation unit 70. Turning the main electronic dial 71 can change settings such as a shutter speed and an aperture value. A power switch 72 is an operation unit that powers on and off the image pickup apparatus 100. A sub electronic dial 73 is a rotational operation unit included in the operation unit 70, and can move a selection frame and advance images. A cross-key 74 is a four-way key included in the operation unit 70 and can be pressed up, down, left, and right. Operations can be performed according to the part of the cross-key 74 that is pressed. A setting button 75 is a push button included in the operation unit 70, and is mainly used to confirm or determine a selected item.

A moving image button 76 is used to instruct the start and stop of moving image capturing (recording). An auto-exposure (AE) lock button 77 is included in the operation unit 70, and by pressing it in the imaging standby state, an exposure state can be fixed. An enlargement button 78 is included in the operation unit 70, and is an operation button for turning on and off the enlargement mode in the live-view display in the imaging mode. Turning on the enlargement mode and operating the main electronic dial 71, a live-view image can be enlarged or reduced. In the playback mode, it functions as an enlargement button for enlarging the playback image and increasing the magnification ratio.

A playback button 79 is included in the operation unit 70, and is an operation button for switching between an imaging mode and a playback mode. Pressing the playback button 79 during the imaging mode can switch the mode to the playback mode, and display the latest image recorded in a recording medium 200, on the display unit 28. A menu button 80 is included in the operation unit 70, and pressing it can display a menu screen in which a variety of settings can be made, on the display unit 28. The user can intuitively make various settings using the menu screen displayed on the display unit 28, the cross-key 74, and the setting button 75.

A communication terminal 10 is a communication terminal for the image pickup apparatus 100 to communicate with a lens unit 150 (which is a lens apparatus attachable to and detachable from the image pickup apparatus 100) described later. An eyepiece unit 16 is an eyepiece unit of an eyepiece finder (a peer-in type finder), and a user can view an image displayed on an internal electronic viewfinder (EVF) 29 through the eyepiece unit 16. An eyepiece detector 57 is an eyepiece detecting sensor that detects whether or not the user has placed his or her eye on the eyepiece unit 16.

A lid 202 covers a slot that houses the recording medium 200. A grip unit 90 is a holder shaped so that the user can easily hold it with the right hand when holding the image pickup apparatus 100. In a case where the image pickup apparatus 100 is held by holding the grip unit 90 with the little finger, ring finger, and middle finger of the right hand, the shutter button 61 and the main electronic dial 71 are located at positions that can be operated with the index finger of the right hand. In the same state, the sub electronic dial 73 is located at a position operable with the thumb of the right hand. A rear imaging unit (first imaging unit) 110 has an image sensor installed on the rear of the image pickup apparatus 100. The rear imaging unit 110 is disposed so that it does not overlap the hand holding the image pickup apparatus 100, and can image the user using it.

Referring now to FIG. 2, a description will be given of the internal configuration of an imaging system 20. FIG. 2 is a block diagram of the imaging system 20. The imaging system 20 includes the image pickup apparatus (camera body) 100 and the lens unit (lens apparatus) 150 that is attachable to and detachable from the image pickup apparatus 100. Each embodiment is not limited to this example, and can also be applied to an image pickup apparatus in which the camera body and lens unit are integrated.

The imaging unit (second imaging unit) 22 performs imaging according to a user's operation. The imaging unit 22 includes an image sensor such as a charge coupled device (CCD) sensor or a complementary metal-oxide-semiconductor (CMOS) sensor that converts an optical image into an electrical signal. An analog signal output from the imaging unit 22 is converted into a digital signal by an A/D converter 23.

An image processing unit 24 performs predetermined pixel interpolation, resizing such as reduction, and color conversion processing for the data from the imaging unit 22 or data from a memory control unit 15 described later. The image processing unit 24 also performs predetermined calculation processing using the captured image data. A system control unit 50 performs exposure control and focus detection control based on the calculation results obtained by the image processing unit 24. Thereby, autofocus (AF) processing and AE processing can be performed using a through-the-lens (TTL) method. The image processing unit 24 also performs predetermined calculation processing using the captured image data, and performs TTL auto white balance (AWB) processing based on the obtained calculation result. Picture style processing is possible, which allows selective setting of a captured image to a color image or a monochrome image as an imaging parameter.

The memory control unit 15 controls data transmission and reception among the imaging unit 22, the image processing unit 24, and a memory 32. The output data from the imaging unit 22 is written into the memory 32 via the image processing unit 24 and the memory control unit 15, or directly via the memory control unit 15. The memory 32 stores image data obtained by the imaging unit 22 and image data to be displayed on the EVF 29. The memory 32 also serves as a memory for image display (video memory). The image data for display written to the memory 32 is displayed on the EVF 29 via the memory control unit 15.

The EVF 29 displays data on a display such as a liquid crystal display (LCD) or an organic electro-luminescence (EL) according to a signal from the memory control unit 15. Sequentially transferring image data stored in the memory 32 to the EVF 29 and displaying it can provide live-view display of the captured image.

A nonvolatile memory 56 is an electrically erasable and recordable memory, such as a flash read only memory (ROM). The nonvolatile memory 56 stores constants and programs for the operation of the system control unit 50. The programs here refer to programs for executing various flowcharts described later in each embodiment.

The system control unit 50 is a control unit having at least one processor or circuit, and controls the entire image pickup apparatus 100. The system control unit 50 executes the program recorded in the nonvolatile memory 56 described above, and thereby achieves each processing of each embodiment described later. A system memory 52 uses, for example, a random access memory (RAM), and stores constants and variables for the operation of the system control unit 50, programs read from the nonvolatile memory 56, and the like. The system control unit 50 also controls display by controlling the memory 32, EVF 29, display unit 28, etc.

A system timer 53 is a time measuring unit that measures the time for various controls and the time of the built-in clock. The extra-finder display unit 43 displays various camera settings such as shutter speed and aperture value via an external-finder display unit (EFD) drive circuit 44.

The operation unit 70, a first shutter switch 62, and a second shutter switch 63 are the operation units for inputting a variety of operation instructions to the system control unit 50. The operation unit 70 is an input unit that accepts operations from the user. The operation unit 70 includes at least one of the shutter button 61, the main electronic dial 71, the power switch 72, the sub electronic dial 73, the cross-key 74, the setting button 75, the moving image button 76, the AE lock button 77, the enlargement button 78, the playback button 79, the menu button 80, the touch panel 81, and the mode switch 82.

The system control unit 50 saves the time of input from any of the operation units as a timestamp in the system memory 52. The timestamp is updated every time an input is made from the operation unit. The system control unit 50 can calculate the non-operation period by comparing the input timestamp with the current timestamp.

The first shutter switch 62 is turned on when the shutter button 61 provided on the image pickup apparatus 100 is half-pressed (imaging preparation instruction) and generates a first shutter switch signal SW1. The first shutter switch signal SW1 starts preparation operations for imaging, such as AF processing, AE processing, AWB processing, and pre-flash (EF) processing. In the AE processing, a proper aperture value, shutter speed, and ISO speed during imaging are calculated and set based on a difference between an exposure amount calculated for the currently set aperture value, shutter speed, and ISO speed and the predetermined proper exposure amount.

The second shutter switch 63 is turned on when the shutter button 61 is fully pressed (imaging instruction) and generates a second shutter switch signal SW2. The system control unit 50 starts a series of imaging processing operations, from reading out the signal from the imaging unit 22 to writing the captured image into the recording medium 200 as an image file, based on the second shutter switch signal SW2.

The touch panel 81 and the display unit 28 can be integrated. For example, the touch panel 81 is configured so that the light transmittance does not interfere with the display of the display unit 28, and is attached to the upper layer of the display surface of the display unit 28. The input coordinates on the touch panel 81 are associated with the display coordinates on the display screen of the display unit 28. Thereby, a graphical user interface (GUI) can be provided, with which the user can directly operate the screen displayed on the display unit 28.

The power switch 72 is an operation unit that powers on and off the image pickup apparatus 100. A power control unit 31 includes a battery detection circuit, a DC-DC converter, a switch circuit that switches the blocks to be energized, etc., and detects whether a battery is attached, a battery type, and the remaining battery level. The power control unit 31 also controls the DC-DC converter based on the detection results and instructions from the system control unit 50, and supplies the required voltage to each unit for the required period of time. The power supply unit 30 includes a primary battery such as an alkaline battery or a lithium battery, a secondary battery such as a NiCd battery, a NiMH battery, or a lithium ion battery, an AC adapter, etc.

A recording medium interface (I/F) 17 is an interface with a recording medium 200 such as a memory card or a hard disk drive. The recording medium 200 is a recording medium such as a memory card for recording a captured image, and includes a semiconductor memory, a magnetic disk, etc.

A communication unit 54 is a connector connectable to an external device. The communication unit 54 connects to an external device wirelessly or via a wired cable, and transmits and receives video signals, audio signals, control signals, etc. The communication unit 54 can also be connected to a wireless local area network (LAN) or the Internet 59. The communication unit 54 can communicate with an external device using High Definition Multimedia Interface (HDMI) (registered trademark) or Universal Serial Bus (USB). The communication unit 54 can also communicate with an external device using Bluetooth (registered trademark) or Bluetooth Low Energy. The communication unit 54 can transmit images (including live-view images) captured by the imaging unit 22 and images recorded on the recording medium 200, and can also receive images and various other information from an external device.

An attitude detector 55 detects the attitude of the image pickup apparatus 100 with respect to the gravity direction. The attitude detector 55 is, for example, an estimator configured to estimate the speed and tilt of the image pickup apparatus 100. An acceleration sensor or a gyro sensor can be used as the attitude detector 55. The attitude detector 55 can detect the movement of the image pickup apparatus 100 (pan, tilt, roll, whether it is stationary, etc.).

A display (movement) position detector 26 detects the position and attitude of the display unit 28 moved by the display movable unit 27. The display position detector 26 can use an angle sensor or a magnetic sensor. The display position detector 26 can detect whether the display unit 28 is rotated by the display movable unit 27 and a rotation amount.

The eyepiece detector 57 can detect (proximity detection) the proximity (eye approach) and separation (eye departure) of the eyeball (eye) 160 to the eyepiece unit 16 of the viewfinder using, for example, an infrared proximity sensor. The system control unit 50 switches between display (display state)/non-display (non-display state) of the EVF 29 according to the state detected by the eyepiece detector 57. The infrared proximity sensor is just an example, and another sensor such as a capacitance type may be used.

The lens unit 150 includes an interchangeable imaging lens. A lens 103 usually includes a plurality of lenses, but here, for simplicity, only a single lens is illustrated. A communication terminal 6 is a communication terminal for the lens unit 150 to communicate with the image pickup apparatus 100. A lens control unit 4 communicates with the system control unit 50 via the communication terminal 6 and the communication terminal 10, and controls a focus state by displacing an aperture stop 1 via an aperture drive circuit 2 and the lens 103 via an AF drive circuit 3. A shutter 101 is a focal plane shutter that can freely control the exposure time of the imaging unit 22 according to the control of the system control unit 50.

The rear imaging unit 110 has an image sensor composed of a CCD sensor or CMOS sensor that converts an optical image into an electrical signal, and is installed on the rear of the image pickup apparatus 100 for imaging in a direction displayed by the display unit 28 or EVF 29. The imaging parameters of the rear imaging unit 110, such as the sensitivity and exposure time, are controlled by the system control unit 50.

The rear imaging unit 110 is installed on the back surface of the image pickup apparatus 100 so as to image the user, but in certain use cases, it becomes difficult to image the user. For example, in a case where the image pickup apparatus 100 is held upward or downward, such as for high-angle or low-angle imaging, it becomes difficult to image the user (it becomes difficult to image the user within an angle of view). In a case where the image pickup apparatus 100 is installed on a tripod and an external remote control is connected to the image pickup apparatus 100, imaging is performed without the user behind the image pickup apparatus 100, and it becomes difficult to image the user.

A rear image analyzer (determination unit) 111 analyzes image data obtained by the rear imaging unit 110 and determines whether or not the user has been imaged. That is, the rear image analyzer 111 determines whether or not the user has been detected in the image obtained by the rear imaging unit 110. In a case where the rear image analyzer 111 detects the user, it notifies the system control unit 50 of the detection result. The rear image analyzer 111 uses, for example, a convolutional neural network, which is widely used in image recognition, as a method for detecting the user. The convolutional neural network detects the user by weighting the eyes, nose, mouth, ears, neck, chin, etc. as a face or part of a face.

The system control unit 50 can set a plurality of operation control states (power states). For example, the system control unit 50 can set the power state to a first power state (a state in which power consumption is reduced) or a second power state in which power consumption is greater than that of the first power state. The system control unit 50 also determines whether or not the user intends to use the electronic apparatus based on the analysis result (determination result) of the rear image analyzer 111 and the user's operation status (predetermined status). The system control unit 50 then sets the power state according to whether or not the user intends to use the electronic apparatus. For example, the system control unit 50 sets the power state to the second power state in the predetermined status, regardless of the determination result of the rear image analyzer 111.

The system control unit 50 can reduce the power consumption of the image pickup apparatus 100, for example, by stopping the operation of the aperture drive circuit 2, the AF drive circuit 3, the imaging unit 22, the display unit 28, the EVF 29, or the EFD drive circuit 44. Alternatively, the system control unit 50 can reduce the power consumption of the image pickup apparatus 100 while degrading performance by reducing the drive cycle of each unit, such as the image read cycle of the imaging unit 22 and the display cycle of the display unit 28.

In each embodiment, the operation control state (first power state) in which the power consumption of the image pickup apparatus 100 is reduced by the system control unit 50 will be referred to as State-L, and the operation control state (second power state) in which the power consumption is not reduced will be referred to as State-H. In a case where the rear image analyzer 111 does not detect a user and it is estimated that the image pickup apparatus 100 is not being used, the system control unit 50 transitions the control state to State-L to reduce power consumption without degrading usability.

### First Embodiment

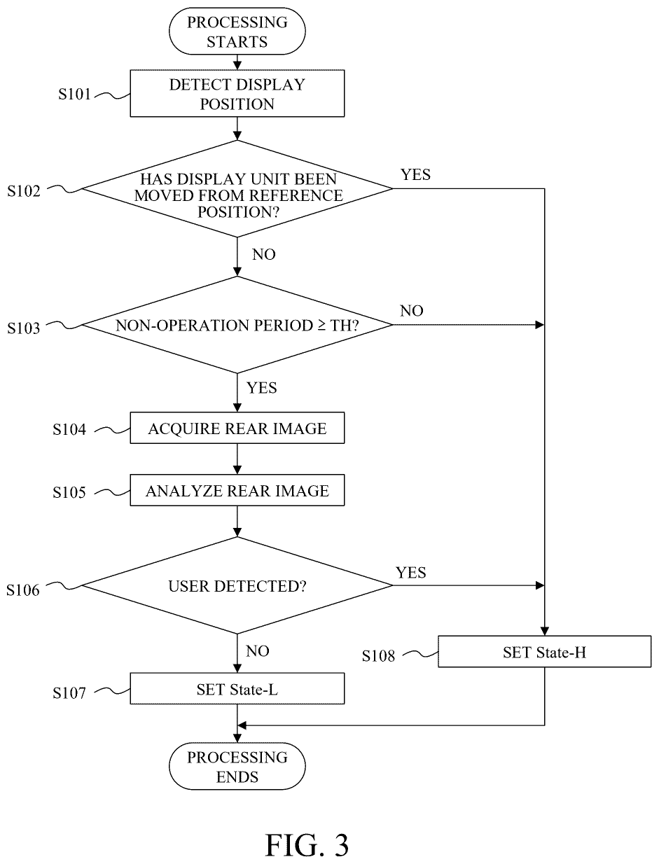

Referring now to FIG. 3, a description will be given of a control method for the image pickup apparatus 100 according to a first embodiment. This embodiment will discuss a method for switching the operation control state of the system control unit 50 according to the position (movement) of the display unit 28 of the image pickup apparatus 100.

FIG. 3 is a flowchart illustrating the processing (control method) of the image pickup apparatus 100 according to this embodiment. Each step in the flowchart of FIG. 3 is achieved by the system control unit 50 in the image pickup apparatus 100 by loading a program stored in the nonvolatile memory 56 into the system memory 52, executing it, and controlling each block.

First, in step S101, the system control unit 50 detects the position of the display unit 28 using the display position detector 26, and receives the detection result. Next, in step S102, the system control unit 50 determines whether or not the display unit 28 has moved from the reference position based on the detection result of the display position detector 26. In a case where it is determined that the display unit 28 has moved from the reference position, the flow proceeds to step S108. On the other hand, in a case where it is determined that the display unit 28 has not moved from the reference position, the flow proceeds to step S103.

In step S103, the system control unit 50 calculates a non-operation period during which the user has not operated the image pickup apparatus 100, and determines whether or not the non-operation period is equal to or greater than a threshold value TH. In a case where it is determined that the non-operation period is equal to or greater than the threshold value TH, the flow proceeds to step S104. On the other hand, in a case where it is determined that the non-operation period is less than the threshold value TH, the flow proceeds to step S108.

In step S104, the system control unit 50 performs imaging using the rear imaging unit 110, and stores the captured image data in the memory 32. Then, in step S105, the system control unit 50 analyzes the image data stored in the memory 32 using the rear image analyzer 111, and receives the analysis result. Then, in step S106, the system control unit 50 determines whether or not a user has been imaged (whether or not a user has been detected) based on the analysis of the image data. In a case where it is determined that a user has been detected, the flow proceeds to step S108. On the other hand, in a case where it is determined that a user has not been detected, the flow proceeds to step S107.

In step S107, the system control unit 50 sets the operation control state (power state) to State-L (first power state). In step S108, the system control unit 50 sets the operation control state to State-H (second power state).

Thus, this embodiment has discussed a method for switching the operation control state of the system control unit 50 according to the position of the display unit 28. In a case where the determination result in step S102 is “Yes,” the display unit 28 has moved from the reference position. In a case where the display unit 28 is in the reference position, it is presumed that the display is difficult to view, and it is presumed that the user is taking a high-angle or low-angle imaging, for example. In such a case, the user is less likely to be imaged by the rear imaging unit 110.

Accordingly, in this embodiment, in a case where the display unit 28 has moved from the reference position, the rear imaging unit 110 does not acquire an image, and the operation control state is set to State-H in step S108. Thereby, the operation control state is prevented from being State-L in a case where the user is taking high-angle or low-angle imaging and the rear imaging unit 110 does not image the user. Therefore, this embodiment can reduce the possibility of an erroneous determination of user detection due to the influence of the operation status of the image pickup apparatus 100, and improve usability.

### Second Embodiment

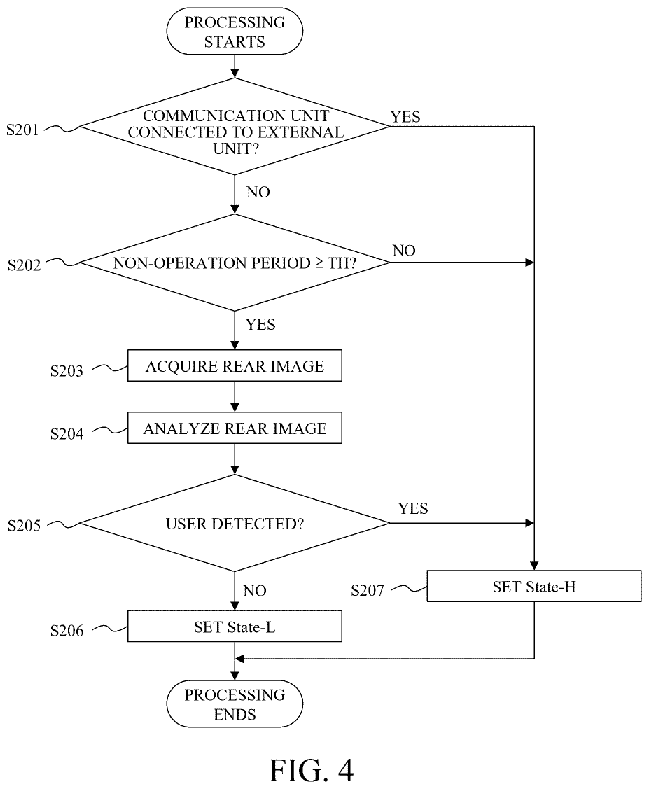

Referring now to FIG. 4, a description will be given of a control method for the image pickup apparatus 100 according to a second embodiment. This embodiment will discuss a method of switching the operation control state of the system control unit 50 according to the connection state between the communication unit 54 of the image pickup apparatus 100 and an external device.

FIG. 4 is a flowchart illustrating the process (control method) of the image pickup apparatus 100 in this embodiment. Each step in the flowchart of FIG. 4 is achieved by the system control unit 50 in the image pickup apparatus 100 by loading a program stored in the nonvolatile memory 56 into the system memory 52, executing it, and controlling each block.

First, in step S201, the system control unit 50 determines whether the communication unit 54 is connected to an external device. In a case where it is determined that the communication unit 54 is connected to the external device, the flow proceeds to step S207. On the other hand, in a case where it is determined that the communication unit 54 is not connected to the external device, the flow proceeds to step S202.

In step S202, the system control unit 50 calculates the non-operation period during which the user does not operate the image pickup apparatus 100, and determines whether the non-operation period is equal to or greater than the threshold value TH. In a case where it is determined that the non-operation period is equal to or greater than the threshold value TH, the flow proceeds to step S203. On the other hand, in a case where it is determined that the non-operation period is less than the threshold value TH, the flow proceeds to step S207.

In step S203, the system control unit 50 performs imaging using the rear imaging unit 110, and stores the captured image data in the memory 32. Next, in step S204, the system control unit 50 analyzes the image data stored in the memory 32 using the rear image analyzer 111, and receives the analysis result. Next, in step S205, the system control unit 50 determines whether or not the user has been imaged (whether or not the user has been detected) based on the analysis of the image data. In a case where it is determined that the user has been detected, the flow proceeds to step S207. On the other hand, in a case where it is determined that the user has not been detected, the flow proceeds to step S206.

In step S206, the system control unit 50 sets the operation control state (power state) to State-L (first power state). In step S207, the system control unit 50 sets the operation control state to State-H (second power state).

Thus, this embodiment has discussed a method for switching the operation control state of the system control unit 50 according to the connection state between the communication unit 54 and the external device. In a case where the determination result in step S201 is “Yes,” since the image pickup apparatus 100 is connected to the external device, it is highly likely that the user is performing an operation at a location away from the image pickup apparatus 100. In such a case, the user is less likely to be imaged by the rear imaging unit 110.

Accordingly, in this embodiment, in a case where the communication unit 54 is connected to the external device, the rear imaging unit 110 does not acquire an image, and the operation control state is set to State-H in step S207. Thereby, the operation control state is prevented from being set to State-L when the user is performing imaging using the external device and the rear imaging unit 110 does not image the user. Therefore, this embodiment can reduce the possibility of an erroneous determination of user detection due to the influence of the operation status of the image pickup apparatus 100, and improve usability.

The communication unit 54 and the external device may be directly connected by a wired connection using a wired LAN, HDMI, USB, or another communication cable, or by a wireless connection such as Bluetooth (registered trademark) or wireless LAN. Alternatively, the communication unit 54 and the external device may be connected via the Internet 59.

### Third Embodiment

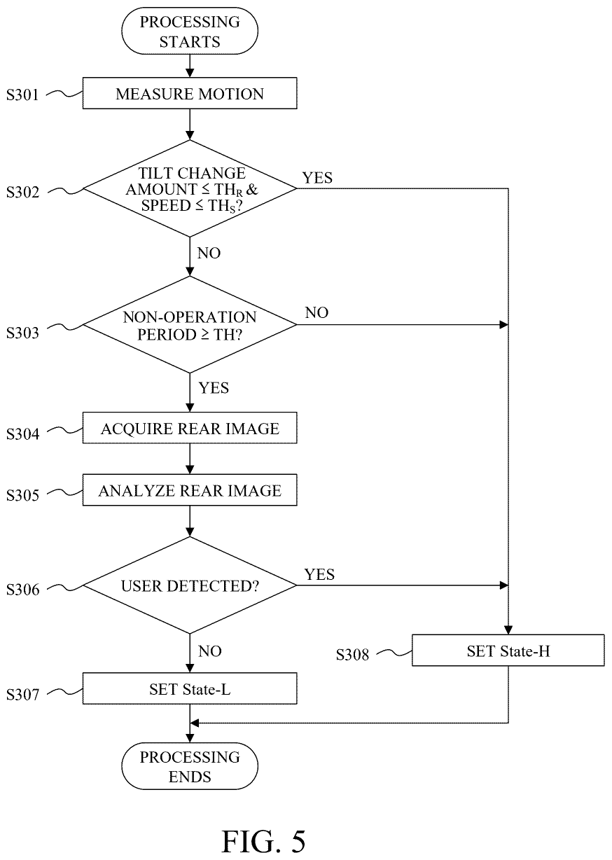

Referring now to FIG. 5, a description will be given of a control method for the image pickup apparatus 100 according to a third embodiment. This embodiment will discuss a method of switching the operation control state of the system control unit 50 according to whether the image pickup apparatus 100 is installed on a installation tool such as a tripod.

FIG. 5 is a flowchart illustrating the processing (control method) for the image pickup apparatus 100 according to this embodiment. Each step in the flowchart in FIG. 5 is achieved by the system control unit 50 in the image pickup apparatus 100 by loading a program stored in the nonvolatile memory 56 into the system memory 52, executing it, and controlling each block.

First, in step S301, the system control unit 50 measures the speed and tilt change of the image pickup apparatus 100 using the attitude detector 55 (performs motion measurement) and receives the measurement result. Next, in step S302, the system control unit 50 determines whether the speed of the image pickup apparatus 100 measured by the attitude detector 55 is equal to or less than a threshold value TH_{S} and whether the tilt change amount is equal to or less than a threshold value TH_{R}. In a case where it is determined that the speed is equal to or less than the threshold value TH_{S} and the tilt change amount is equal to or less than the threshold value TH_{R} (In a case where both conditions are satisfied), the flow proceeds to step S308. On the other hand, in a case where it is determined that the speed is greater than the threshold value TH_{S} or the tilt change amount is greater than the threshold value TH_{R} (in a case where at least one of the two conditions is not satisfied), the flow proceeds to step S303.

In step S303, the system control unit 50 calculates the non-operation period during which the user does not operate the image pickup apparatus 100, and determines whether the non-operation period is equal to or greater than the threshold value TH. In a case where it is determined that the non-operation period is equal to or greater than the threshold value TH, the flow proceeds to step S304. On the other hand, in a case where it is determined that the non-operation period is less than the threshold value TH, the flow proceeds to step S308.

In step S304, the system control unit 50 performs imaging using the rear imaging unit 110, and stores the captured image data in the memory 32. Next, in step S305, the system control unit 50 analyzes the image data stored in the memory 32 using the rear image analyzer 111, and receives the analysis result. Next, in step S306, the system control unit 50 determines whether the user has been imaged (whether the user has been detected) as a result of the analysis of the image data. In a case where it is determined that a user has been detected, the flow proceeds to step S308. On the other hand, In a case where it is determined that a user has not been detected, the flow proceeds to step S307.

In step S307, the system control unit 50 sets the operation control state (power state) to State-L (first power state). In step S308, the system control unit 50 sets the operation control state to State-H (second power state).

Thus, this embodiment has discussed a method for switching the operation control state of the system control unit 50 according to whether the image pickup apparatus 100 is installed on an installation tool such as a tripod. In a case where the determination result in step S302 is “Yes,” it can be determined that the speed and the tilt change amount of the image pickup apparatus 100 are both small, and the image pickup apparatus 100 is stationary. Therefore, it is presumed that the image pickup apparatus 100 is installed on the installation tool such as a tripod. In using a tripod, the user may be imaging from a remote location away from the image pickup apparatus 100 by operating a remote operation unit such as a remote controller, and the user may not be imaged by the rear imaging unit 110.

Accordingly, in this embodiment, in a case where it is estimated that the image pickup apparatus 100 is installed on the installation tool such as a tripod, the rear imaging unit 110 does not acquire an image, and the operation control state is set to State-H in step S308. Thereby, the operation control state is prevented from being set to State-L when the user is performing imaging with the image pickup apparatus 100 installed on the installation tool such as a tripod and the rear imaging unit 110 does not image the user. Therefore, this embodiment can reduce the possibility of an erroneous determination of user detection due to the influence of the operation status of the image pickup apparatus 100, and improve usability.

In this embodiment, the attitude detector 55 is used to measure the speed and tilt change amount, but the measurement unit is not limited to this example. For example, the speed and tilt change amount may be estimated by analyzing and calculating the motion vector of the object in the image from a group of images continuously shot by the imaging unit 22 or the rear imaging unit 110. In this embodiment, in a case where the speed is equal to or less than the threshold value TH_{S} and the change in tilt is equal to or less than the threshold value TH_{R} in step S302, the process transitions to step S308, but the transition condition is not limited thereto. For example, the process may be configured to transition to step S308 when the speed is equal to or less than the threshold value TH_{S} or the change in tilt is equal to or less than the threshold value TH_{R}.

In each embodiment, the system control unit 50 determines whether or not the user has an intention to use based on the determination result of the rear image analyzer 111 and the user's operation status, and sets the power state (first power state or second power state) according to whether or not the user intends to use the electronic apparatus. In a case where the system control unit 50 determines that the operation unit 70 has not been operated for a predetermined time or more, the system control unit 50 may set the power state based on the user's intention to use the electronic apparatus. In a case where the system control unit 50 determines that the user does not have an intention to use, the system control unit 50 may set the power state to the first power state. In a case where the system control unit 50 determines that the user has an intention to use, the system control unit 50 may set the power state to the second power state. The rear image analyzer 111 may determine whether or not a user has been detected based on whether or not at least a part of the user's face has been detected in the image.

The system control unit 50 may determine that there is an intention to use when the rear image analyzer 111 determines that the user has been detected for a predetermined time or more. The system control unit 50 may determine that there is an intention to use when it determines that the operation status is a status in which the user is operating, regardless of the determination result of the rear image analyzer 111.

The power state may be a power state of at least one of the imaging unit 22 or the display unit 28. The operation status may be a status regarding whether or not the position (attitude) of the display unit 28 has been changed from a reference position. The operation status may be a status regarding whether or not the image pickup apparatus 100 is connected to an external device by the communication unit 54. The operation status may be a status regarding whether or not the image pickup apparatus 100 is attached to an installation tool such as a tripod.

The image pickup apparatus 100 may include an attitude detector 55 configured to detect the speed and tilt change amount of the image pickup apparatus 100. The system control unit 50 determines that the image pickup apparatus 100 is installed in the installation tool when the speed of the image pickup apparatus 100 is equal to or less than a predetermined speed, or when the tilt change amount of the image pickup apparatus 100 in a predetermined time is equal to or less than a predetermined change amount.

In each embodiment, the system control unit 50 determines whether or not there is a user's intention to use based on the determination result of the rear image analyzer 111 and the user's operation status. However, each embodiment is not limited to this example, and it is not essential to determine whether or not there is a user's intention to use, and it is sufficient to determine, for example, whether or not there is a predetermined status (or whether or not a predetermined condition is satisfied). In the predetermined status (in a case where the predetermined condition is satisfied), the system control unit 50 can set the power state to the normal power state (second power state) regardless of the determination result of the rear image analyzer 111.

The predetermined status here is a status regarding the position of the display unit 28, the connection status with an external device, or the motion of the image pickup apparatus 100, but is not limited to them. The predetermined status may be another status such as a status regarding the imaging mode. The imaging mode may include, for example, a mode for moving the display unit 28 from a reference position and performing imaging, a mode for connecting the electronic apparatus to an external device and performing imaging, or a mode for attaching the image pickup apparatus 100 to an installation tool such as a tripod and for imaging, but is not limited to them. The imaging mode may be set by the user, for example. Due to such a configuration, the system control unit 50 may perform processing of determining the status of the set imaging mode, for example, instead of S102 in FIG. 3, S201 in FIG. 4, or S301 and S302 in FIG. 5. In each embodiment, the user detection function may be turned on and off according to a user setting.

In each embodiment, the order of the determination processing in the flowchart is not limited to the order illustrated in each figure. For example, in the flowchart in FIG. 3, the order of S102, S103, and S106 may be properly changed, such as performing S106 before step S102. This is similarly applicable to the flowcharts in FIGS. 4 and 5.

In each embodiment, “regardless of the determination result of the rear image analyzer 111” means, for example, that the rear image analyzer 111 does not determine whether or not a user has been detected (such as not operating the rear image analyzer 111 or turning off the function of the rear image analyzer 111). However, each embodiment is not limited to this example, and the system control unit 50 may be configured not to acquire the determination result of the rear image analyzer 111 (not inputting a signal indicating the determination result of the rear image analyzer 111, or ignoring the signal even if it is input).

In each embodiment, the control of the system control unit 50 may be performed by a single hardware unit, or a plurality of hardware units may share the processing to control the entire image pickup apparatus 100. Each embodiment has discussed the image pickup apparatus 100 as an electronic apparatus, but is also applicable to another electronic apparatus such as a smartphone.

Each embodiment can provide an electronic apparatus, a control method for the electronic apparatus, and a storage medium, each of which can reduce the possibility of an erroneous determination of user detection due to the influence of the operation status.

### OTHER EMBODIMENTS

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an electronic apparatus that can reduce the possibility of an erroneous determination of user detection due to the influence of an operating status.

This application claims priority to Japanese Patent Application No. 2024-097626, which was filed on Jun. 17, 2024, and which is hereby incorporated by reference herein in its entirety.

What is claimed is:

1. An electronic apparatus comprising:
a first imaging unit including a first image sensor; and
at least one processor that executes instructions to:
determine whether a user is detected in an image acquired by the first imaging unit, and
set a power state to a first power state or a second power state consuming more power than that of the first power state according to a determination result and an operation status of a user.

2. The electronic apparatus according to claim 1, further comprising an operation unit configured to accept an operation from the user,
wherein the processor is configured to set the power state according to a non-operation period of the operation unit.

3. The electronic apparatus according to claim 1, wherein the processor is configured to set the power state to the first power state in a case where the processor determines that a predetermined condition is not satisfied.

4. The electronic apparatus according to claim 1, wherein the processor is configured to set the power state to the second power state in a case where the processor determines that a predetermined condition is satisfied.

5. The electronic apparatus according to claim 1, wherein the processor is configured to determine whether the user has been detected according to whether at least a part of a face of the user has been detected in the image.

6. The electronic apparatus according to claim 1, wherein the processor is configured to set the power state to the second power state in a case where the processor determines that the user has been detected for a predetermined time.

7. The electronic apparatus according to claim 1, wherein the processor is configured to set the power state to the second power state in a case where the processor determines that the user is operating the electronic apparatus, regardless of the determination result.

8. The electronic apparatus according to claim 1, further comprising a second imaging unit configured to include a second image sensor and perform imaging according to an operation of the user,
where the power state is a power state of the second imaging unit.

9. The electronic apparatus according to claim 1, further comprising a display configured to display an image captured by a second imaging unit configured to perform imaging according to an operation of the user,
wherein the power state is a power state of the display unit.

10. The electronic apparatus according to claim 9, wherein the operation status is a status as to whether a position of the display unit has been changed from a reference position.

11. The electronic apparatus according to claim 1, further comprising a connector connectable to an external device,
wherein the operation status is a status as to whether the electronic apparatus is connected to the external device by the connector.

12. The electronic apparatus according to claim 1, wherein the operation status is a status as to whether the electronic apparatus is attached to an installation tool.

13. The electronic apparatus according to claim 12, wherein the processor is configured to estimate a speed and a tilt of the electronic apparatus, and
wherein in a case where the speed is equal to or less than a predetermined speed, or in a case where a tilt change amount in a predetermined time is equal to or less than a predetermined change amount, the processor is configured to determine that the electronic apparatus is installed in the installation tool.

14. An electronic apparatus comprising:
a first imaging unit including a first image sensor; and
at least one processor that executes instructions to:
determine whether a user is detected in an image acquired by a first imaging unit,
set a power state to a first power state or a second power state consuming more power than that of the first power state according to a determination result, and
set the power state to the second power state in a predetermined status regardless of a determination result.

15. The electronic apparatus according to claim 14, wherein the processor is configured not to determine whether the user is detected in the image in the predetermined status.

16. The electronic apparatus according to claim 14, wherein the processor is configured not to acquire the determination result in the predetermined status.

17. The electronic apparatus according to claim 14, wherein the predetermined status is a status regarding a position of a display unit, a connection state with an external device, a motion of the electronic apparatus, or an imaging mode.

18. The electronic apparatus according to claim 17, wherein the imaging mode is set by the user.

19. A control method of an electronic apparatus comprising:
determining whether or not a user is detected in an image acquired by a first imaging unit including a first image sensor; and
setting a power state to a first power state or a second power state consuming more power than that of the first power state according to a determination result and an operation status of a user.

20. A non-transitory computer-readable storage medium storing a program that causes a computer to execute the control method according to claim 19.
